(19) United States
(12) Patent Application Publication
(10) Pub. No.: US 2015/0327615 A1
(43) Pub. Date: Nov. 19, 2015

(54) HELM LIGHT

(71) Applicant: Jacob Gelb, Brooklyn, NY (US)

(72) Inventor: Jacob Gelb, Brooklyn, NY (US)

(21) Appl. No.: 14/715,510

(22) Filed: May 18, 2015

Related U.S. Application Data
(60) Provisional application No. 61/994,746, filed on May 16, 2014.

(51) Int. Cl. A42B 3/04; A42B 3/08; F21L 4/00; F21V 7/00; F21V 33/00; F21L 4/08

(52) U.S. Cl. CPC A42B 3/044; F21V 33/0076; F21L 4/08; F21L 4/00; F21V 7/0083; A42B 3/0446; A42B 3/08; F21Y 2103/003

(57) ABSTRACT

A bicycle safety helmet with Light Emitting Diodes or LED Lights, comprising: a lightweight and high quality protective helmet made of impact resistant, micro shell plastic exterior that encases a molded, shock absorbent, EPS polymeric foam liner, further comprising a bright white LED headlight and an array of red LED lights along the helmet's sides and back.

### CLAIM OF PRIORITY

This patent application claims priority under 35 USC 119 (e) (1) from U.S. Provisional Patent Application Ser. No. 61/994,746 filed May 16, 2014, of common inventorship herewith entitled, “HELM LIGHT,” which is incorporated herein by reference as though the same were set forth in its entirety.

### FIELD OF THE INVENTION

The present invention pertains to the field of bicycle accessories, and more specifically to the field of bicycle safety helmets.

### BACKGROUND OF THE INVENTION

The prior art has put forth several designs for bicycle safety helmets. Among these are:

US Patent 2012/0243210 to Stephon Deshron Brown describes a multiply purpose helmet shell that has more than one light emitting diodes embedded in the shell. The helmet shell is designed and constructed in such a way to give visual identification to the wearer. The multiply purpose helmet shell lighting system is powered by battery and other lithium ion or dry cell batteries that are mounted within or on the helmet shell. The lighting system is turned on and off manually or automatically.

US Patent 2009/0086468 to James Carillo describes a bicycle helmet that includes lights providing illuminating beams toward a rider's upper torso. The lights reside on a downward and rearward facing surface of an elongated rear portion of the bicycle helmet. A light assembly unit is mounted to the elongated rear portion of the bicycle helmet. The light assembly unit includes one or more light elements, a power source, and a switch. The light elements are preferably Light Emitting Diodes or LEDs that provide a long battery life.

U.S. Pat. No. 5,508,900 to Charles H. Norman describes a bicycle helmet for protecting the head and face of an individual and for alerting surrounding persons to a presence of such individual. The inventive device includes an exterior shell having a pair of signal lights mounted in a forward portion thereof. The signal lights are selectively operated to attract attention of motor vehicle drivers or the like to a presence of the individual during nighttime conditions.

None of these prior art references describe the present invention.

### SUMMARY OF THE INVENTION

It is an object of the present invention to provide a bicycle safety helmet equipped with Light Emitting Diodes or LED Lights.

### BRIEF DESCRIPTION OF THE DRAWINGS

FIG. 1 is an illustrative prototypical slightly diagonal side view showing an LED light residing on the front surface of the present invention.

FIG. 2 is an illustrative prototypical side view showing side reflectors and a power and light mode selection button residing on the side surface of the present invention.

FIG. 3 is an illustrative prototypical slightly diagonal back view showing a rechargeable battery pack and LED lights residing on the back surface of the present invention.

FIG. 4 is an illustrative prototypical back view showing an LED light residing on the back surface of the present invention.

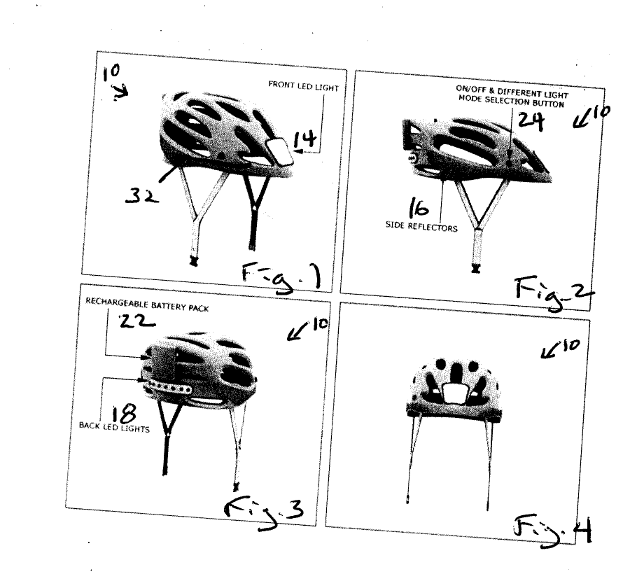

### DETAILED DESCRIPTION OF THE INVENTION

Like swimming, riding a bicycle is a recreation that individuals often learn and do early in their lives and then never forget. Bicycling provides great pleasure and benefits ranging from improved physical fitness and cardiovascular health to self independence and confidence one enjoys when getting from one place to another by any chosen route and completely on one's own. Bikes provide a young rider with freedom, responsibility and escape. A kid on a bike has freedom in riding and responsibility in getting home in one piece. In a youngster's imagination, their bike is anything from a knight's stallion to a gunslinger's pony, a World War I biplane or a Star Wars fighter. The bond between a kid and a bike is sacrosanct, much like the bond some adults have with their cars or motorcycles, but sweeter, because it is a first love. And for millions of adults who appreciate the finer things in life such as fresh air, exercise and freedom to wander at their own pace, the first love of bicycling never dies.

Today's bicycles are manufactured in an astonishing variety of styles, models and price ranges including stunt bikes, mountain bikes, road racers, beach cruisers, stretch cruisers, low riders, town bikes, recumbent bikes and comfort bikes. This variety provides cyclists with a wealth of functionality and components that were unthinkable just a few decades ago. When the rubber meets the road, even the snazziest bike leaves its rider at the mercy of motor vehicles with which they share the road. A prudent cyclist exercises a high level of caution when riding and wears a protective safety helmet. Bike helmets come in many styles and prices ranging from approximately twenty five to three hundred dollars. These helmets absolutely save one's life in the event of a head impact.

The present invention, hereinafter referred as Helm Light, is a bicycle safety helmet that incorporates battery powered, Light Emitting Diode or LED lights. These LED lights function to illuminate a nighttime cyclist's path and make a cyclist highly visible to motorists approaching from a cyclist's front, side or rear.

Helm Light is a lightweight and high quality protective helmet 10 with a unique safety component of bright LEDs incorporated into the helmet. Streamlined and aerodynamic, Helm Light comprises a tough, impact resistant, micro shell plastic exterior that encases a molded, shock absorbent, EPS polymeric foam liner. The present invention is produced in small, medium, large sizes and a universal size with an adjustable fit interior headband. Extensively vented for coolness, the Helm Light Helmet contains an adjustable padded chinstrap. Helm Light Helmets are produced in a variety of colors and embellished with a variety of graphics.

Incorporated on the surface of the Helm Light helmet is a bright white LED headlight 14 and an array of red LED lights along the helmet's sides 16 and back 18. Each side of the helmet contains a reflector strip 32 that curves around to the back of the helmet. The LED lights are powered by three AAA cell batteries or a rechargeable lithium ion battery pack. The battery or batteries are housed in a snap locking battery compartment 22 that resides underside the top of the helmet. A power cord, adapter and charger are included with Helm Lights that are using a rechargeable battery. Pushbutton controls 24 for the headlight, side lights and rear lights are situated on the side of the helmet. These controls 24 permit a user to select a steady beam or a flashing headlight, as well as several alternative flashing sequences for the red side and rear LED arrays. The front, sides and rear of the Helm Light are finished with red or orange reflective strips.

With multi light capability, Helm Light becomes a protective gear piece, headlight, tail light and reflector all in one helmet. The Helm Light's headlight is an improvement over conventional bicycle headlights because it moves along with a cyclist's head to illuminate areas where light is needed. Because the Helm Light contains flashing red side and rear lights, a cyclist is assured to be highly visible to other cyclists and motorists. LEDs provide powerful and focused light while consuming little power, so the Helm Light is reliable, bright and economical to operate.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A bicycle safety helmet with Light Emitting Diodes or LED Lights, comprising: a lightweight and high quality protective helmet made of impact resistant, micro shell plastic exterior that encases a molded, shock absorbent, EPS polymeric foam liner, further comprising a bright white LED headlight and an array of red LED lights along the helmet's sides and back.

2. The bicycle safety helmet of claim 1, further comprising reflector strips on the sides of the helmet contains that curves around to the back of the helmet.

3. The bicycle safety helmet of claim 1, wherein the LED lights are powered by three AAA cell batteries or a rechargeable lithium ion battery pack.

4. The bicycle safety helmet of claim 3, wherein the battery or batteries are housed in a snap locking battery compartment that resides underside the top of the helmet.

5. The bicycle safety helmet of claim 3, wherein a power cord, adapter and charger are included with the rechargeable battery.

6. The bicycle safety helmet of claim 1, further comprising push button controls for the headlight, side lights and rear lights, and the pushbutton control are situated on the side of the helmet.

7. The bicycle safety helmet of claim 6, wherein the push button controls permit a user to select a steady beam or a flashing headlight, as well as several alternative flashing sequences for the red side and rear LED arrays.

8. The bicycle safety helmet of claim 1, wherein the helmet is produced in small, medium, large sizes and a universal size with an adjustable fit interior headband.

9. The bicycle safety helmet of claim 1, wherein the helmet is Extensively vented for coolness, and the helmet further comprises an adjustable padded chinstrap.

10. The bicycle safety helmet of claim 1, wherein helmet is produced in a variety of colors and embellished with a variety of graphics.

11. The bicycle safety helmet of claim 3, wherein the helmet is produced in small, medium, large sizes and a universal size with an adjustable fit interior headband.

12. The bicycle safety helmet of claim 3, wherein the helmet is Extensively vented for coolness, and the helmet further comprises an adjustable padded chinstrap.

13. The bicycle safety helmet of claim 3, wherein helmet is produced in a variety of colors and embellished with a variety of graphics.

14. The bicycle safety helmet of claim 6, wherein the helmet is produced in small, medium, large sizes and a universal size with an adjustable fit interior headband.

15. The bicycle safety helmet of claim 6, wherein the helmet is Extensively vented for coolness, and the helmet further comprises an adjustable padded chinstrap.

16. The bicycle safety helmet of claim 6, wherein helmet is produced in a variety of colors and embellished with a variety of graphics.
